(19) United States
(12) Patent Application Publication
(10) Pub. No.: US 2015/0156333 A1
(43) Pub. Date: Jun. 4, 2015

(54) BYOD-SPONSORED DATA INTEGRATION

(71) Applicant: Liberty Mutual Insurance Company, Boston, MA (US)

(72) Inventors: Jane Ann Ford, Boston, MA (US); Vincent Thomas Kasabian, Boston, MA (US); Michael Wesley Klein, Boston, MA (US); Russell Bernard Coit, Boston, MA (US); Mary Ellen Morse, Boston, MA (US)

(21) Appl. No.: 14/618,669

(22) Filed: Feb. 10, 2015

Related U.S. Application Data
(60) Provisional application No. 61/941,221, filed on Feb. 18, 2014.

(51) Int. Cl. H04M 15/00; H04W 4/26

(52) U.S. Cl. CPC H04M 15/60; H04W 4/26

(57) ABSTRACT

A Bring Your Own Device (BYOD) process allows isolation of data usage between corporate and personal endpoints. This process promotes BYOD usage in a corporate environment because of the ability to segregate data (i.e., corporate or personal). This enables BYOD users to bear the financial responsibility of data transmitted as part of such users' personal data plan and not data transmitted for corporate use. The process enhances productivity of corporate employees by removing cost barriers created by accessing corporate data on personal data plans.

### CROSS-REFERENCE TO RELATED APPLICATION

This application claims the benefit of U.S. Provisional Application No. 61/941,221, filed Feb. 18, 2014, which is incorporated herein by reference.

### TECHNICAL FIELD

The present subject matter is generally related to mobile computing, and more particularly, it relates to electronically differentiating personal data from corporate data on a mobile computer.

### BACKGROUND

At the end of 2012, there were roughly 1.5 billion mobile broadband subscriptions, growing at a 50% year-on-year rate. Mobile broadband subscriptions are expected to reach 6.5 billion in 2018. Mobile broadband is the term for wireless Internet access through a mobile phone, tablet or other mobile devices. Mobile data traffic doubled between the end of 2011 (620 PetaBytes in 2011) and the end of 2012 (1280 PetaBytes in 2012). This traffic growth is likely to be driven by large increases in the number of smartphones being sold, the use of more demanding applications, and in particular, video and the availability and deployment of newer 3G and 4G technologies capable of higher data rates. By 2018, total mobile broadband traffic is expected to increase by a factor of 12 to roughly 13,000 PetaBytes. Employees conventionally bring their own mobile devices into a corporate network setting and use the mobile devices for personal data consumption as well as for corporate data use. These employees are bearing the financial responsibility of accessing corporate network on their personal data plans. This is a problem.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1-2 are pictorial drawings.

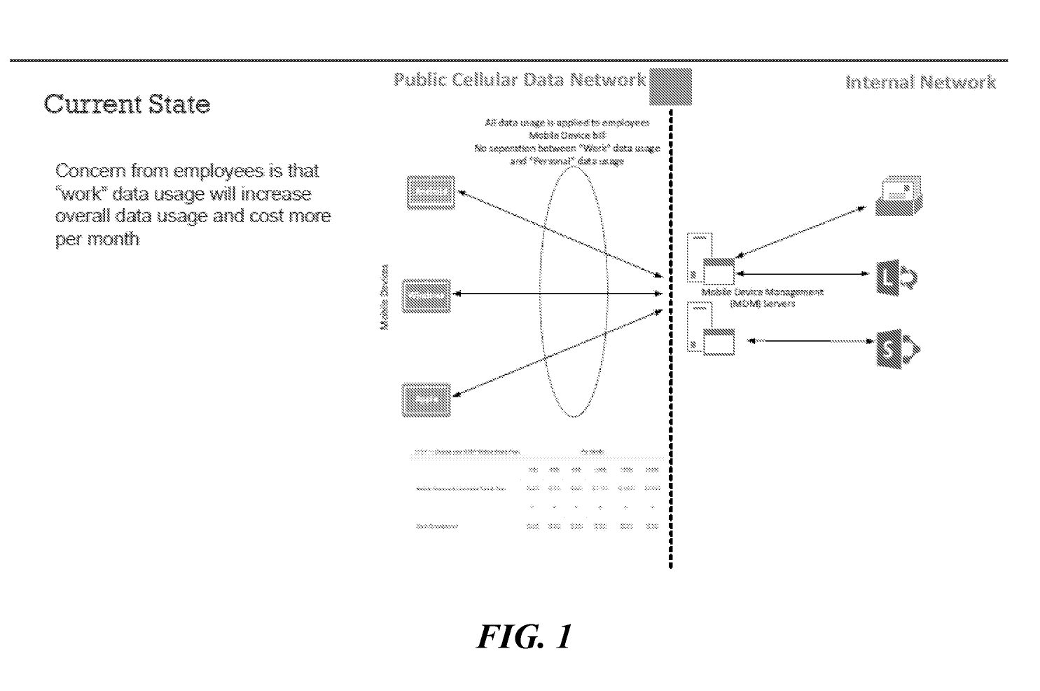

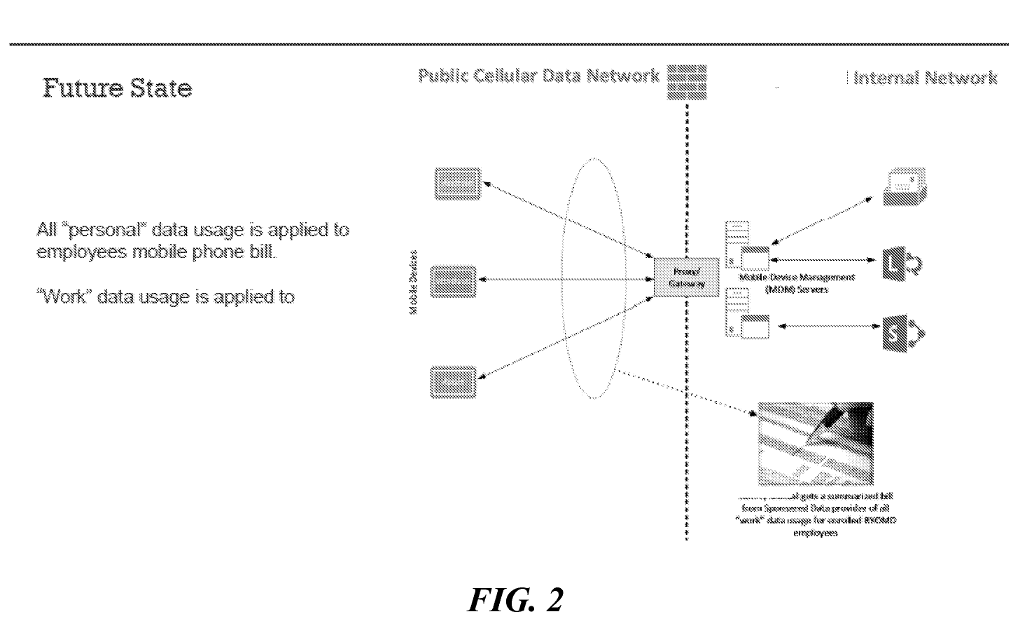

### DETAILED DESCRIPTION

Various embodiments of the present subject matter are engineered to focus on sponsored data services which are used for Web and mobile applications. Various embodiments engineer flags to be set on data streams in order to differentiate personal data consumption from data used for corporate purposes. These flags allow billing of data used for corporate purposes to be identified for accounting. In a few embodiments, these flags are set using HTTP headers. Various embodiments engineer a method and/or a gateway that facilitates billing to be made to the corporation for mobile devices communicating for work via a sponsored data service. In many embodiments, gateway/proxy hardware is networked in front of mobile-device management devices to provide the sponsored data network the flags in the datastream for tracking, identifying, and billing.

The BYOD (Bring Your Own Device)-sponsored data integration process leverages a sponsored data model in conjunction with a corporate Bring Your Own Device (BYOD) process, allowing isolation of data usage between corporate and personal endpoints. A sponsored data model is a model by which data is transmitted at no cost to the user in a corporate network setting. The BYOD-sponsored data integration process promotes BYOD usage in a corporate environment because of the ability to segregate data (i.e., corporate or personal). This enables BYOD users to bear the financial responsibility of data transmitted as part of such users' personal data plan and not data transmitted for corporate use. The BYOD-sponsored data integration process enhances productivity of corporate employees by removing cost barriers created by accessing corporate data on personal data plans.

Various embodiments focus on applying a sponsored data plan to BYOD users so as to facilitate the segregation of corporate data from personal data when determining associated data costs. Various embodiments isolate corporate from personal data by defining corporate data using either DNS or IP schemes. Various embodiments may tag corporate e-mail to identify corporate data.

While the embodiments of the invention have been illustrated and described, it will be appreciated that various changes can be made therein without departing from the spirit and scope of the invention.

The embodiments of the invention in which an exclusive property or privilege is claimed are defined as follows:

1. A system with hardware structures as substantially illustrated and described.

2. A method with electronically enabled steps as substantially described.

3. A computer-readable medium as substantially described.
